(19) United States
(12) Patent Application Publication
(10) Pub. No.: US 2020/0319688 A1
(43) Pub. Date: Oct. 8, 2020

(54) DEVICE MONITORING SYSTEM

(71) Applicant: Shenzhen Fugui Precision Ind. Co., Ltd., Shenzhen (CN)

(72) Inventors: HSIAO-PING HSUEH, Taoyuan (TW); YU-CHI TSAI, New Taipei (TW); HONG-MING LAN, New Taipei (TW)

(21) Appl. No.: 16/394,354

(22) Filed: Apr. 25, 2019

(30) Foreign Application Priority Data
Apr. 3, 2019 (CN) 201910267510.8

(51) Int. Cl. G06F 1/26; G06F 1/3206; H04L 12/10

(52) U.S. Cl. CPC G06F 1/266; H04L 12/10; G06F 1/3206

(57) ABSTRACT

A system for monitoring power usage includes a power distribution unit (PDU) and a monitoring device. The PDU includes a detecting module and a storing module, the monitoring device includes an amplifying module and a processing module. The detecting module obtains signal as to voltage and current relating to a power supply, and the storing module stores data as to calibration. The amplifying module obtains the signal as to voltage and current, and amplifies the same. The processing module obtains the amplified signal and processes the amplified to obtain data as to electrical flow. The processing module can obtain calibration data from the storing module, and apply corrections according to the calibration data.

### FIELD

The subject matter herein generally relates to a system for monitoring a network device.

### BACKGROUND

Developers can perform a calibrating process on a power distribution unit (PDU) and a monitoring device to calibrate and apply working parameters. The monitoring device corrects its data according to the parameters to meet accuracy requirements. There are components inside the monitoring device that affect the corrections, the PDU needs to re-execute the calibration process to generate new parameters, otherwise the accuracy of the monitored data will be affected.

Therefore, there is a room for improvement.

### BRIEF DESCRIPTION OF THE DRAWINGS

Implementations of the present disclosure will now be described, by way of embodiments, with reference to the attached figures.

FIG. 1 is a diagram of an embodiment of a system to monitor a device.

FIG. 2 is a block diagram of an embodiment of the device of FIG. 1.

FIG. 3 is a block diagram of an embodiment of a device used in the system of FIG. 1.

FIG. 4 is a diagram of another embodiment of the system.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

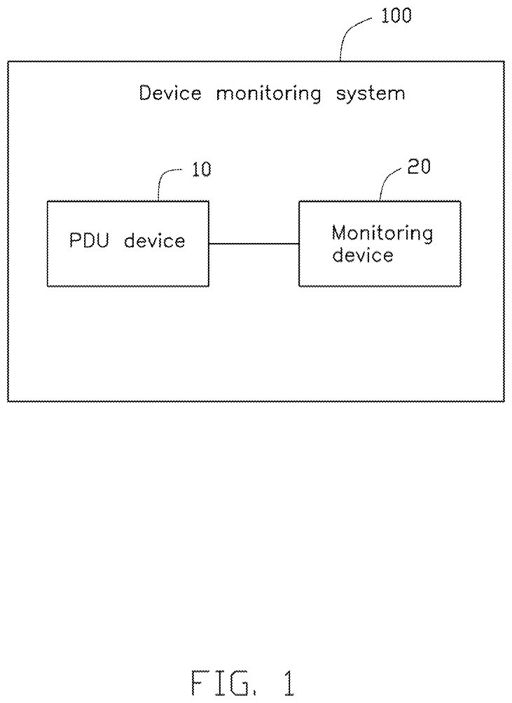

FIG. 1 illustrates a device monitoring system 100 in accordance with an embodiment of the present disclosure.

The device monitoring system 100 includes a power distribution unit (PDU) device 10 and a monitoring device 20. The monitoring device 20 is connected to the PDU device 10.

When the monitoring device 20 is inserted into the PDU device 10, the monitoring device 20 is electrically coupled to the PDU device 10.

The PDU device 10 supplies and allocates power to each of a plurality of electrical devices 30, the monitoring device 20 monitors power supplied and allocated by the PDU device 10.

In at least one embodiment, information related to the supply and allocation of power (hereinafter power information) includes voltage and current.

The monitoring device 20 sends the power information of the PDU device 10 to a remote management system (not shown in figures), and the remote management system can output signal to a manager according to the power information.

When the PDU device 10 is overloaded, the remote management system outputs an alert message to the manager, to reduce the number of electrical devices 30 connected to the PDU device 10.

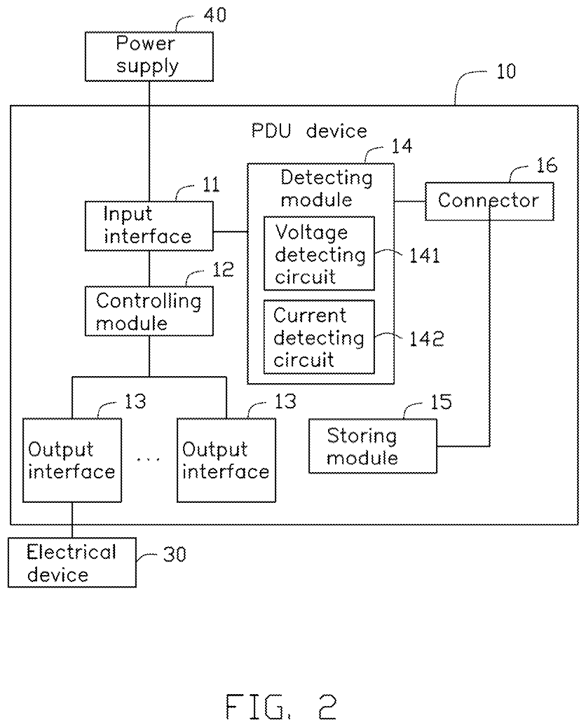

FIG. 2 illustrates that the PDU device 10 includes an input interface 11, a controlling module 12, and a plurality of output interfaces 13.

The controlling module 12 is electrically coupled between the input interface 11 and the plurality of output interfaces 13. The input interface 11 is electrically coupled to a power supply 40.

The controlling module 12 controls the power output of each output interface 13, one output interface 13 being electrically coupled to one electrical device 30. In at least one embodiment, at least one of the electrical devices 30 can be a server.

In at least one embodiment, the PDU device 10 further includes a detecting module 14, a storing module 15, and a connector 16.

The detecting module 14 is electrically coupled between the input interface 11 and the connector 16, and the storing module 15 is electrically coupled to the connector 16.

The detecting module 14 obtains signal as to power (power signal) from the input interface 11, and outputs the power signal to the monitoring device 20 through the connector 16.

The storing module 15 stores calibration data. In at least one embodiment, the storing module 15 can be an electrically erasable programmable read only memory (EEPROM).

In at least one embodiment, the detecting module 14 includes a voltage detecting circuit 141 and a current detecting circuit 142, the power signal includes signals as to voltage and current.

The voltage detecting circuit 141 obtains the voltage level and the current detecting circuit 142 obtains the current level, from the power signal.

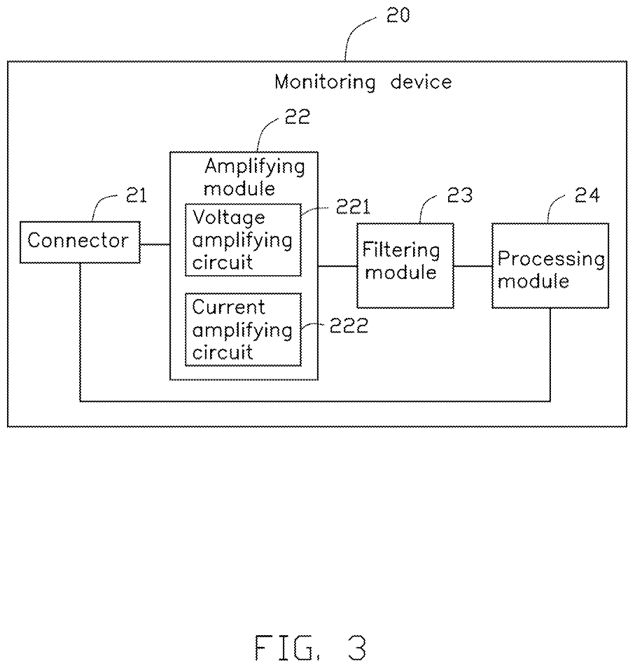

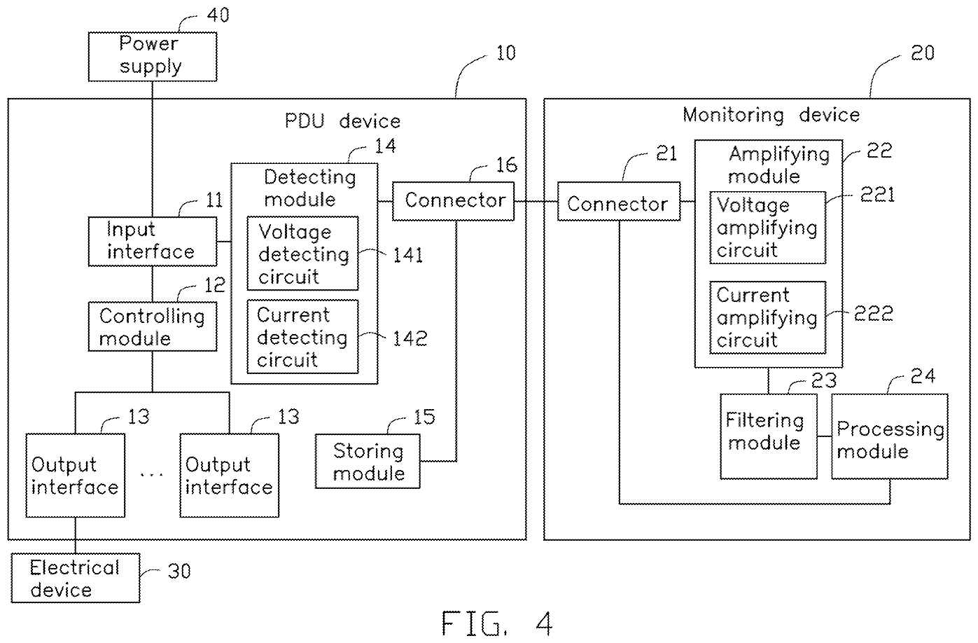

FIGS. 3 and 4 illustrate that the monitoring device 20 includes a connector 21, an amplifying module 22, a filtering module 23, and a processing module 24.

The amplifying module 22 is electrically coupled between the connector 21 and the filtering module 23, the filtering module 23 is electrically coupled to the processing module 24, and the connector 21 is electrically coupled to the processing module 24.

When the connector 21 is plugged into the connector 16, the PDU device 10 is electrically coupled to the monitoring device 20. The amplifying module 22 communicates with the detecting module 14 through the connector 21 and the connector 16, and the processing module 24 communicates with the storing module 15 through the connector 21 and the connector 16.

The amplifying module 22 obtains the power signal from the detecting module 14, and amplifies the power signal before transmitting same to the filtering module 23.

The filtering module 23 filters the power signal amplified by the amplifying module 22, to filter out noise in the power signal and transmit the filtered power signal to the processing module 24.

In at least one embodiment, the amplifying module 22 includes a voltage amplifying circuit 221 and a current amplifying circuit 222.

The voltage amplifying circuit 221 is electrically coupled to the voltage detecting circuit 141 through the connector 21 and the connector 16, and the current amplifying circuit 222 is electrically coupled to the current detecting circuit 142 through the connector 21 and the connector 16.

The voltage amplifying circuit 221 obtains the voltage level from the voltage detecting circuit 141, and amplifies the voltage level.

The current amplifying circuit 222 obtains the current level from the current detecting circuit 142, and amplifies the current level.

The processing module 24 obtains the power signal from the filtering module 23, and processes the power signal to calculate and obtain power data.

The processing module 24 also obtains the calibration data from the storing module 15. The processing module 24 can apply corrections according to the calibration data, and the data as to power signal and corrections can be sent to the remote management system. In at least one embodiment, the data as to power and corrections includes voltage data and current data.

In at least one embodiment, a calibration device (not shown) performs a calibration process to update the calibration data, and stores the updated calibration data to the storing module 15.

The calibration device is electrically coupled to the input interface 11. The calibration device is electrically coupled to the processing module 24 and the storing module 15. The calibration device obtains the power signal from the input interface 11, and processes the power signal to obtain data regarded as standard (standard data). The calibration device obtains the data related to power and corrections, and compares such data with the standard data to obtain an updated calibration data. The calibration device transmits the updated calibration data to the storing module 15 to store the updated calibration data.

Therefore, when the monitoring device 20 is inserted into the PDU device 10, the monitoring device 20 can directly acquire the data as to corrections stored in the storing module 15 independently of the calibration process.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A device monitoring system, comprising:
a power distribution unit (PDU) device comprising:
a detecting module obtaining power signal from a power supply; and
a storing module storing calibration data;
a monitoring device electrically coupling to the PDU device, and comprising;
an amplifying module obtaining and amplifying the power signal to obtain amplified power signal; and
a processing module obtaining the amplified power signal and calculating the amplified power signal to obtain power data; wherein the processing module obtains the calibration data from the storing module, and corrects the power data according to the calibration data.

2. The device monitoring system of claim 1, wherein the monitoring device further comprises a filtering module, and the filtering module is electrically coupled between the processing module and the amplifying module.

3. The device monitoring system of claim 2, wherein the filtering module filters the amplified power signal.

4. The device monitoring system of claim 1, wherein the PDU device further comprises a first connector, the monitoring device further comprises a second connector, and the first connector is electrically coupled to the second connector.

5. The device monitoring system of claim 4, wherein the PDU further comprises an input interface, the input interface is electrically coupled to the power supply.

6. The device monitoring system of claim 5, wherein the detecting module is electrically coupled between the input interface and the first connector, and the amplifying module is electrically coupled between the second connector and the processing module.

7. The device monitoring system of claim 6, wherein the detecting module further comprises a voltage detecting circuit and a current detecting circuit, the voltage detecting circuit and the current detecting circuit are electrically coupled to the input interface.

8. The device monitoring system of claim 7, wherein the power signal comprises voltage signal and current signal, the voltage detecting circuit obtains the voltage signal, and the current detecting circuit obtains the current signal.

9. The device monitoring system of claim 8, wherein the amplifying module further comprises a voltage amplifying circuit and a current amplifying circuit, the voltage amplifying circuit is electrically coupled to the voltage detecting circuit through the first connector and the second connector, and the current amplifying circuit is electrically coupled to the current detecting circuit through the first connector and the second connector.

10. The device monitoring system of claim 9, wherein the voltage amplifying circuit amplifies the voltage signal, and the current amplifying circuit amplifies the current signal.

11. The device monitoring system of claim 10, wherein the storing module is electrically coupled to the first connector, the processing module is electrically coupled to the second connector, and the storing module is electrically coupled to the processing module through the first connector and the second connector.

12. The device monitoring system of claim 10, wherein the storing module is an electrically erasable programmable read only memory (EEPROM).

13. A device monitoring system, comprising:
a power distribution unit (PDU) device comprising:
a detecting module obtaining power signal from a power supply; and
a storing module storing calibration data;
a monitoring device electrically coupling to the PDU device, and comprising;
an amplifying module obtaining and amplifying the power signal from the detecting module to obtain amplified power signal;
a filtering module filtering the amplified power signal to obtain filtered power signal; and
a processing module obtaining the filtered power signal and calculating the filtered power signal to obtain power data; wherein the processing module obtains the calibration data from the storing module, and corrects the power data according to the calibration data.

14. The device monitoring system of claim 13, wherein the PDU device further comprises a first connector, the monitoring device further comprises a second connector, and the first connector is electrically coupled to the second connector.

15. The device monitoring system of claim 14, wherein the PDU further comprises an input interface, the input interface is electrically coupled to the power supply.

16. The device monitoring system of claim 15, wherein the detecting module is electrically coupled between the input interface and the first connector, and the amplifying module is electrically coupled between the second connector and the processing module.

17. The device monitoring system of claim 16, wherein the detecting module further comprises a voltage detecting circuit and a current detecting circuit, the voltage detecting circuit and the current detecting circuit are electrically coupled to the input interface.

18. The device monitoring system of claim 17, wherein the power signal comprises voltage signal and current signal, the voltage detecting circuit obtains the voltage signal, and the current detecting circuit obtains the current signal.

19. The device monitoring system of claim 18, wherein the amplifying module further comprises a voltage amplifying circuit and a current amplifying circuit, the voltage amplifying circuit is electrically coupled to the voltage detecting circuit through the first connector and the second connector, and the current amplifying circuit is electrically coupled to the current detecting circuit through the first connector and the second connector.

20. The device monitoring system of claim 19, wherein the voltage amplifying circuit amplifies the voltage signal, and the current amplifying circuit amplifies the current signal; wherein the storing module is electrically coupled to the first connector, the processing module is electrically coupled to the second connector, and the storing module is electrically coupled to the processing module through the first connector and the second connector.
